(19) United States
(12) Patent Application Publication
(10) Pub. No.: US 2013/0159049 A1
(43) Pub. Date: Jun. 20, 2013

(54) AUTOMATIC RISK CALIBRATION OF ROLES IN COMPUTER SYSTEMS

(71) Applicants: SAYEKUMAR ARUMUGAM, FOSTER CITY, CA (US); RAVIKANTH ERUKULLA, MILPITAS, CA (US); JOHN CHRISTOPHER RADKOWSKI, LOS ALTOS HILLS, CA (US)

(72) Inventors: SAYEKUMAR ARUMUGAM, FOSTER CITY, CA (US); RAVIKANTH ERUKULLA, MILPITAS, CA (US); JOHN CHRISTOPHER RADKOWSKI, LOS ALTOS HILLS, CA (US)

(21) Appl. No.: 13/326,473

(22) Filed: Dec. 15, 2011

(51) Int. Cl. G06Q 10/00

(52) U.S. Cl. 705/7.28

(57) ABSTRACT

Various embodiments of systems and methods for automatic calibration a risk level of a role are described herein. Automatically and periodically a risk level of a role is evaluated based on various risk factors associated with the role. Risk factors' values are determined by respective risk factor aggregators. Risk factors are assigned weights to determine their influence degree on the risk level of the role. The risk level of the role is computed by a risk calibration engine based on the determined risk factors' values and assigned weights, respectively.

### FIELD

Embodiments of the invention generally relate to the software arts, and more specifically, to risk management.

### BACKGROUND

In an enterprise, various roles are created often to represent various job functions in computer systems. Within an enterprise, a role may be defined as an abstraction that encompasses a specified bundle of business duties, and the corresponding access to functionality and resources required to carry out those duties. Users are assigned particular roles to obtain permissions to perform certain tasks, such as groupings of one or more related transactions for specific business process. These transactions may be business-related or technical activities performed in a computer system. For example, a common business process is “procure to pay” and one task related to this process may be “vendor maintenance” including several transactions, such as “create vendor”, “change vendor”, “maintain vendor”, “block vendor”, etc.

Usage of roles may expose an organization to adverse circumstances or to a possibility of loss. The risks associated with various roles may vary from one role type to another. For example, through a role users may be granted access to sensitive applications and data such as personal data, financial data, customer lists, and other types of confidential data. A role that provides access to such data or applications typically entails higher risk as opposed to a role that lacks such access. Another example of a role that entails higher risk is a role that holds combinations of access privileges that could enable users to commit fraud, for example, a role that is in violation of separation-of-duty policies. Therefore, it may be advantageous to determine and assess the risk associated with a role so that, for example, high-risk roles are identified and monitored. Identifying such high-risk roles may facilitate the elimination or mitigation of the negative impact on an organization that might be caused as a result of misuse of such roles.

### SUMMARY

Various embodiments of systems and methods for automatic calibration of a level of risk of a role in a computer system are described herein. According to one aspect, an aggregator tracks value of a risk factor associated with the role in the computer system. Further, a weight associated with the risk factor is retrieved to determine a degree of influence the risk factor has over the level of risk of the role. A risk calibration engine computes the level of risk of the role based on the tracked value of the risk factor and the retrieved weight. According to another aspect, the level of risk is calibrated against a comparative level of risk of the role. In yet another aspect, if the current level of risk exceeds a threshold, mitigation risk strategies are formulated. The risk calibration engine may prioritize the role based on the risk level.

The aggregator periodically updates the value of the risk factor. The risk calibration engine computes the current level of risk of the role in response to the updates. Further, the risk calibration engine computes the current level of risk of the role in response to a change of the weight associated with the risk factor.

Risk factors include, but are not limited to, authorization risk factor determined based on access permissions of the role to resources in the computer system; application access risk factor determined based on access of the role to critical applications; inherent risk factor determined based on access of the role to conflicting transactions, incidents risk factor determined based on violations of said role, time sensitive risk factor determined based on the time when a transaction of the role occurs; and outdated certification risk factor determined based on certification of the role.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 illustrates an exemplary system environment for automatic calibration of a risk level of a role, according to one embodiment.

FIG. 2 illustrates exemplary risk factors associated with a role, according to one embodiment.

FIG. 3 illustrates a process for automatic calibration of a risk level of a role, according to one embodiment.

FIG. 4 illustrates a process for automatic calibration of risk level of roles by a risk calibration engine, according to one embodiment.

FIG. 5 illustrates a computing environment in which the techniques described for automatic calibration of a risk level of a role can be implemented, according to one embodiment.

### DETAILED DESCRIPTION

Embodiments of techniques for risk calibration of roles in computer systems are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

Roles are used to control access to computer system resources. Users are assigned to different roles based on their competencies and responsibilities in an organization. When a user of a computer system is granted a particular role, he or she gains the permissions rendered to this role in the system. For example, a role “accountant” within an organization may have the specific permissions to check accounts, prepare financial statements, access and change orders, etc.

Roles are logical groupings of permissions that reflect one or more tasks that can be assigned to a user. The control over system resources that users gain through roles may lead to fraud, loss, or other negative effects on an organization, if any of the users misuse or exploit the granted access rights inappropriately. Therefore, roles may be characterized by corresponding levels of risk according to the level of control the roles grant over the computer systems, and the importance of the computer systems for an organization. In one embodiment, automatic calibration of the risk level of a role is implemented.

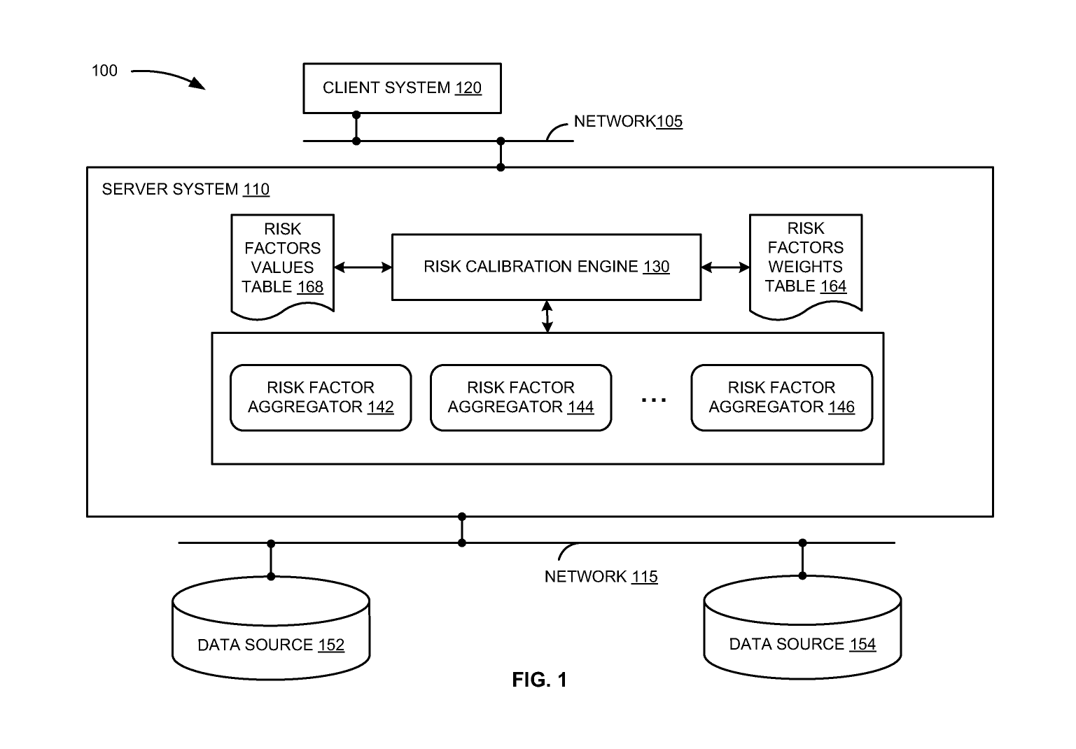

FIG. 1 illustrates exemplary system environment 100 where automatic calibration of a level of risk of a role in a computer system is implemented, according to one embodiment. System 100 includes a client system 120 coupled to a server system 110 through network 105, e.g. the Internet, intranet, or other public or private computer network. System 100 resembles a simplified client-server computer environment architecture.

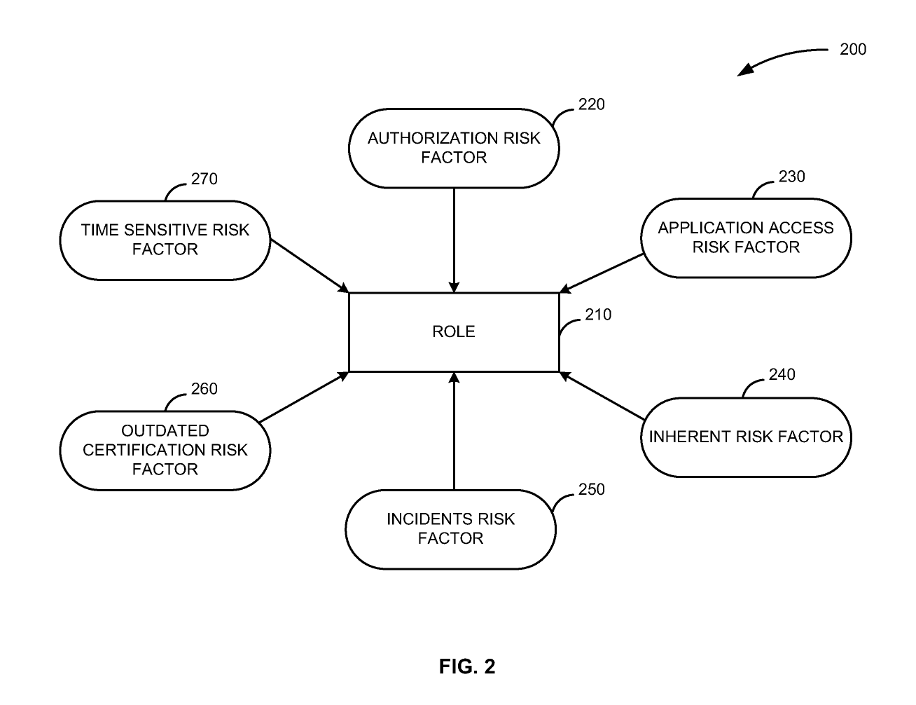

Server system 110 includes, among other components, risk calibration engine 130 and risk factor aggregators 142-146. An aggregator is a computer module designed to track and determine values of one or more risk factors associated with a role. Risk factors may be traceable attributes or other observable aspects of a role that influence the risk level associated with the role. Risk factors may be based on various features, configurations, or usages of a role, e.g., types of data to which the role has access to, access to one or combination of transactions granted to a role, log data of when and how a role has been exploited by users, etc. A transaction may be defined as an atomic technical action that is related to and is included in specific business process. A combination of one or more transactions may form a business process. Further, a transaction may represent a discrete business activity. Risk factors may be implicit characteristics related to a role that are used to calibrate or determine the risk level of the role. Exemplary risk factors 220-270 associated with role 210 are illustrated in FIG. 2.

In one embodiment, for each risk factor that may be associated with a role, a specific risk factor aggregator may be designed to determine and track the value of the respective risk factor. Back to FIG. 1, risk factor aggregators 142-146 are modules that register to the risk calibration engine 130. Risk factor aggregators 142-146 retrieve data from data sources 152-154 to determine the value of the risk factors of the role. A network 115 may be provided to connect the server system 110 to data stores 152-154.

In one embodiment, data source 152 may be a role management system that deals with automatic definition and management of roles. Roles that are distributed across various systems and applications may be centrally maintained in a unified repository included in data source 152. Example of such role management system is SAP® GRC Enterprise Role Management (ERM) application.

In one embodiment, data source 154 may be a system that is used to identify, analyze, and mitigate or resolve risk and audit issues that relate to regulatory compliance. Example of such system is SAP® GRC Risk Analysis and Remediation (RAR) application. In one embodiment, data sources 152-154 may be part of a Governance, Risk and Compliance (GRC) framework such as SAP® BusinessObjects™ GRC.

Once risk factor aggregators 142-146 determine the values of the respective risk factors associated with a role, the values are populated to risk factors values table 168. In an embodiment, risk calibration engine 130 populates the determined values to the risk values table 168. In yet another embodiment, the values may be populated to the risk factors values table by the risk factor aggregators 142-146. In table 168 risk factor values are retained and may be updated periodically or as needed.

In one embodiment, weights are defined and assigned to corresponding risk factors. A weight is a quantitative value assigned to a risk factor to determine an influence degree of the risk factor to the overall level of a risk of a role. In one embodiment, a user such as an administrator of the risk calibration engine 130 may assign weights to respective risk factors. Weights are retained in risk factors weights table 164.

Risk calibration engine 130 computes a current level of risk of a role based on value of at least one risk factor and at least one weight assigned to the at least one risk factor. The level of risk of a role is determined as frequently as needed. For example, risk factor aggregators 142-146 may be triggered periodically to estimate the values of respective risk factors. In one embodiment, engine 130 determines the risk level of a role on a continuous basis. In various embodiments the level of risk may be determined at time intervals, such as daily, weekly, monthly, quarterly, and/or yearly. In one embodiment, the risk calibration engine 130 computes the current level of risk of the role in response to a change of at least one weight assigned to at least one risk factor associated with the role.

In one embodiment, the risk calibration engine 130 calibrates the current level of risk of the role against a comparative level of risk of the role. For example, the current level of risk may be compared to or checked against the comparative level risk. A comparative level of risk of the role may be any value to which the current level of risk of the role may be compared. For example, a median, a desirable, a historical, a standard value or any other values of risk level of the role.

In one embodiment, the risk calibration engine 130 indicates when the current level of risk is different to the comparative level of risk of the role. For example, if a risk level of a role increases compared to a stored value of the risk level, an alert may be dispatched to client system 120. Also, in an embodiment, risk calibration engine may indicate when the level of risk of a role exceeds a predefined threshold. A high-risk role may be defined as a role with level of risk that exceeds a predefined threshold.

FIG. 2 illustrates correspondence 200 between exemplary risk factors 220-270 and role 210, according to one embodiment. Examples of risk factors associated with a role include, but are not limited to, authorization risk factor 220, application access risk factor 230, inherent risk factor 240, incidents risk factor 250, outdated certification risk factor 260, and time sensitive risk factor 270. In one embodiment, a value of an attribute of a role may determine the value of a risk factor associated with the role. For example, the authorization risk factor 220 is based on access privileges or permissions of a role to resources of a computer system, including various transactions and electronic data. A number of roles in a computer system may have authorizations to perform specific transactions. The value of the authorization risk factor 220 is determined based on the access privileges of role 210. For example, a read-execute access implies higher risk than a read-only access privilege, since an execute privilege allow a user to not only access data, but also to modify it. Thus, a user assigned to such a role gains more control via an execute privilege that may be misused. Typically, administrator roles have higher level of permissions than other regular roles. For example, such roles entail the power to make system-wide changes. A user granted an administrator role may have the ability to adversely affect a whole system or systems. Thus, the value of the authorization risk factor for such a role may be higher in comparison to other roles. In one embodiment, the value of the authorization risk factor 220 is determined as the total number of transactions for which role 210 has an execute access. In another embodiment, the value of the authorization risk factor 220 may be determined as a ratio of the overall number of transactions to which role 210 has access to and the number of transactions with an execute access.

Another risk factor that may influence the risk associated with role 210 is the application access risk factor 230. An access to certain sensitive or critical transactions as part of a business process may involve higher risk than the access to others. For example, the access to transaction “vendor payment” has higher risk than the access to transaction “create order”, since if the transaction “vendor payment” is misused this may lead to higher loss for the organization compared to the “create order” transaction, e.g., it may lead to direct pecuniary loss. Other examples of sensitive transactions include, but are not limited to, operations with personal data, financial data, customer lists, confidential information, etc. The value of the application access risk factor 230 may be determined based on the number of sensitive or critical transactions role 210 has access to.

Inherent risk factor 240 may be determined based on access rights to conflicting transactions. Conflicting transactions may be defined as a combination of two or more transactions that, when assigned to a single role, and respectively to a single user, create a vulnerability. Two or more transactions may be determined as conflicting if their combination violates segregation-of-duties policies or rules that are placed in an organization. A common example of a segregation-of-duties violation is granting the same role, the ability to create vendors and pay to vendors. A user to whom a role with both of these privileges is granted has the possibility to set up fake vendors and pay them fraudulently, resulting in financial and legal damages for the organization. Other examples of conflicting or incompatible transactions include, but are not limited to, authorizing a transaction in combination with receiving and maintaining custody of an asset that resulted from the transaction; receiving checks for payment on account in combination with approving write-offs; depositing cash in combination with reconciling bank statements; approving time cards in combination with having custody of pay checks; etc. The value of the inherent risk factor 240 may be based on the number of conflicting transactions role 210 has access to.

In one embodiment, data source 154 in FIG. 1 may be RAR application. RAR application may be used to detect and prevent segregation-of-duties violations. For example, in RAR application a set of segregation-of-duties conflicts may be defined. In one embodiment, inherent risk factor 240 may be based on the number of segregation-of-duties conflicts identified and detected in role 210, where segregation-of-duties conflicts are defined in data source 154.

Incidents risk factor 250 is a further aspect of role 210 that influences its risk level. The incidents risk factor 250 is determined based on violations of role 210. For example, the incidents risk factor 250 is based on fraudulent abuse of the rights granted via role 210. If a role was previously abused, then such role is vulnerable to fraud and entails higher incidents risk. In an embodiment, the value of the incidents risk factor 250 is determined as the number of times role 210 was abused. It is possible that the value of incidents risk factor 250 is null, for example, when no fraudulent activities of users to whom role 210 is granted were detected.

Yet another factor that influences risk level of role 210 is outdated certification risk factor 260. The outdated certification risk factor 260 is determined based on certification of role 210. Commonly, enterprises should comply with industry and government regulations, such as Sarbanes-Oxley Act of 2002, regarding controls over access to sensitive data and other organizational assets. Thus, organizations may be required to certify roles, for example, on quarterly or semi-annual basis, to analyze access privileges and verify that they are appropriate, correct and consistent with various policies. If a role is past its due certification date, the risk level associated with the role increases. The value of outdated certification risk factor 260 may be determined as the number of overdue certifications of role 210. In one embodiment, the value of outdated certification risk factor 260 is null or minimal when role 210 is certified in compliance with imposed certification periods.

An additional risk factor associated with role 210 is time sensitive risk factor 270. The time sensitive risk factor 270 is determined based on a time when a transaction occurs. If a user accesses data, systems, applications, or transactions during a period in which access is not permitted or is unusual, the risk level associated with the corresponding role granted to the user increases. For example, access to a general ledger application during a close period to post a journal entry increases likelihood of fraud, and respectively, the risk level associated with the abused role increases. Another example is accessing an organization's balance sheet during close period before the results are officially announced. Such user actions might be associated with fraud and other violations of security rules and policies. The value of the time sensitive risk factor 270 may be determined based on the number of times users using role 210 had accessed computer system resources during unauthorized time periods when the respective resources should not be accessed. In one embodiment, a list of critical or sensitive time periods is defined, and may be stored as a setup data.

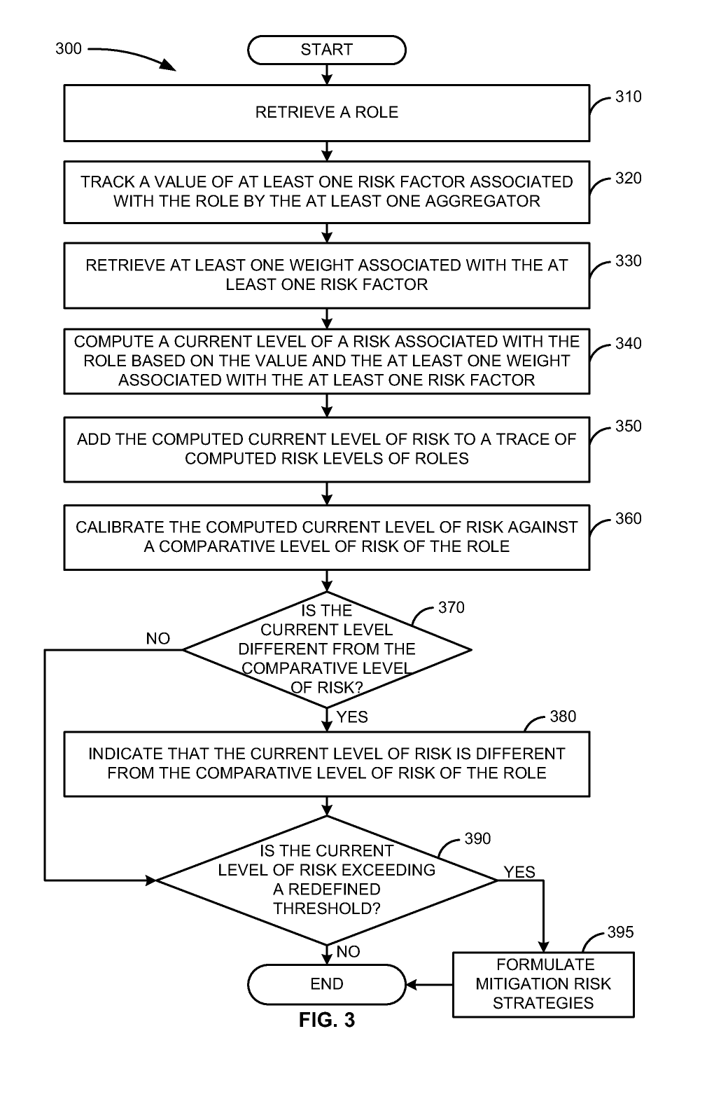

FIG. 3 illustrates process 300 for automatic calibration of a level of risk of a role in a computer system, according to one embodiment. The process starts at 310 with retrieving a role. In one embodiment, a role is selected from a number of roles maintained in an enterprise role repository, where definition of roles are kept and may be accessed. Attributes and other descriptive information of the role are retrieved. For example, role information that is retrieved includes, but is not limited to, role name or other role identification; authorized business processes, sub-business processes, and any related transactions to which the role provides access; system or systems to which the role gives access; period of validity of the role; related company or organization with which the role is associated; functional area of the role; approver of the role such as dedicated user assigned to authorize the provisioning of the role to any users; and any other attributes a role may have.

At 320, a value of at least one risk factor associated with a role is tracked by at least one risk factor aggregator. In one embodiment, the at least one risk factor aggregator extracts from a memory at least one data value of at least one attribute of the role to determine and track the value of the at least one risk factor. Data values of various attributes or other aspects of a role may be retrieved from various data sources such as data sources 152-154 in FIG. 1. Such data values may be derived from data including, but not limited to, audit reports that may contain records of role certification; activity log files; risk analysis reports that may include records of violations with a role; codes of transactions to which a role has access to; role attributes as defined in role repository, etc. Risk factor aggregators, such as risk factor aggregators 142-146 in FIG. 1, determine and track values of corresponding risk factors associated with a role.

Examples of risk factor aggregators include, but are not limited to, authorization risk factor aggregator that determines the value of authorization risk factor 220 (in FIG. 2), application access risk factor aggregator that determines the value of the application access risk factor 230, inherent risk factor aggregator that determined the value of the inherent risk factor 240, incidents risk factor aggregator that determines the value of incidents risk factor 250, outdated certification risk factor aggregator that determines the value of the outdated certification risk factor 260, and time sensitive risk factor aggregator that determined the value of the time sensitive risk factor 270.

The type of data that a risk factor aggregator retrieves depends on the respective risk factor. For example, authorization risk factor aggregator to determine the value of authorization risk factor 220 may retrieve authorization information of the role from the role definition specified in the ERM application. The retrieved authorization data include level of access related to the privileges. For example, if a level of access to data is a “read-only” access or “read-and-write” access. Similarly, the application access risk factor aggregator to determine the value of the application access risk factor 230 retrieves authorization data from the role definition. The inherent risk factor aggregator to determine the value of the inherent risk factor 240 may retrieve role definition data such as functions and transactions to which the role has access to and respective permissions. Further, the inherent risk factor aggregator may retrieve segregation-of-duties rules defined and kept in tables in the RAR application to determine if the role has access to conflicting transactions as defined in the retrieved rules. The time sensitive risk factor to determine the value of the time sensitive risk factor 270 may retrieve critical or sensitive time periods from a configured table. The value of the time sensitive risk factor may be determined based on number of times of times users using the role had accessed computer system resources during time periods defined in the table. The outdated risk factor aggregator to determine the value of the outdated certification risk factor 260 may retrieve role certification data from the ERM application. Certification data may be stored in a table and associated with each role. Certification information may include which user certified a role, when was the role certified, due date for the certification, etc. The incidents risk factor aggregator to determine the value of the incidents risk factor 250 may retrieve data from transaction logs and activity reporting data bases.

In an embodiment, the determined values of respective risk factors of a role are populated to and retained in a risk factors values table such as table 168 in FIG. 1. Table 1 below illustrates an exemplary risk factors values table for a role.

TABLE 1

| Risk Factor | Value (rᵢ) |
|---|---|
| Authorization risk factor | 3 |
| Application access risk factor | 4 |
| Inherent risk factor | 1 |
| Incidents risk factor | 3 |
| Outdated certification risk factor | 0 |
| Time Sensitive risk factor | 0 |

Value “3” of the authorization risk factor in Table 1 indicates that three read-execute access permissions to various resources are defined for the role. The value of the authorization risk factor is determined by the authorization risk factor aggregator by counting the number of read-execute permissions the role has for various transactions and/or functions. Value “4” of the application access risk factor indicates that the role has access to four sensitive transactions. The value of the application access risk factor is determined by the application access risk factor aggregator by analyzing the critical transactions to which the role has access to. Value “1” of the inherent risk factor indicates that one separation-of-duties violation of the role is identified. The value of the inherent risk factor is determined by the inherent risk factor aggregator by tracking the separation-of-duties violations identified in the role. Value “3” of the incidents risk factor indicates that users misused the role three times. The incidents risk factor aggregator determines the value of the incidents risk factor by aggregating the occurrences of fraud or other violations of the rights and permissions granted via the role. The value of the certification risk factor is zero since the role is certified in the required periods. Similarly, the value of the time sensitive risk factor is zero since no user activity occurred during defined sensitive time periods.

At 330, at least one weight that is associated with the at least one risk factor is retrieved. In one embodiment, weights are retained in risk factor weights table, such as table 164 in FIG. 1. Table 2 illustrates an exemplary risk factors weights table for a role:

TABLE 2

| Risk Factor | Weight (wᵢ) |
|---|---|
| Authorization risk factor | w1 |
| Application access risk factor | w2 |
| Inherent risk factor | w3 |
| Incidents risk factor | w4 |
| Outdated certification risk factor | w5 |
| Time Sensitive risk factor | w6 |

Weights “wᵢ” are retrieved and used to determine the influence degree or contribution of risk factors to the overall risk level of the role. In one embodiment, weights may be user defined. In yet another embodiment, weights may be automatically adjusted and defined based on a predefined rule.

At 340, a current level of risk associated with the role is computed based on the determined value of the at least one risk factor and the associated weight of the at least one factor. In one embodiment, a weighted average formula is used to compute the risk level associated with a role:

$$Role Risk Level = \frac{{\sum }_{i = 1}^{n} wi \times ri}{{\sum }_{i = 1}^{n} wi} \qquad Formula 1$$

Where “rᵢ” denotes the value of a risk factor associated with the role, “wᵢ” denotes the respective weight associated with the risk factor, and “n” is the number of risk factors associated with the role. Using the above illustrated formula, the risk calibration engine computes an average of the risk factors' values “rᵢ”, where risk factors have different degrees of importance as specified by weights “wᵢ”. Thus, the risk level of a role is computed as a composite value based on various risk factors. In an embodiment, one or more weights may be zero and at least one weight is a positive number. A risk factor may be assigned zero weight to render the risk factor unimportant, for example, when a certain risk factor is irrelevant to the an organization's business domain or needs. Also, the values of one or more risk factors may be null, but at least the value of the authorization risk factor should be positive, since a role has access to at least one transaction, function or application.

At 350, the computed level of risk may be added to a trace of computed risk levels of roles. A trace with computed values of risk level of roles may be kept in data sources 152-154. For example, when a risk level of a role is computed the value of the risk level along with identification of the respective role may be stored in a table.

At 360, the computed current level of risk is calibrated against a comparative level of risk of the role. The current level of risk may be compared to and checked against the comparative value of the risk of the role. For example, a check is performed whether the current level of risk is higher than the comparative level of risk. In an embodiment, a comparative level of risk of the role may be a value of the risk level of the role that is stored in a trace with computed risk levels of roles. Example of such value may be the old value of the risk level of the role before the risk level is updated. In other embodiments, a comparative level of risk of the role may be an average value of the risk level of the role or an average value of risk level of defined roles. In yet other embodiments, a standard threshold may be set as a comparative value.

At 370, a check is performed whether the current level of risk of the role is different from the comparative level of risk. At 380, it is indicated if the current level of risk is different from the comparative level of risk of the role. For example, alert message may be send to administrator or owner of the role. If the current risk level of the role is higher, a role administrator based on the indication may impose risk mitigation controls or other actions to eliminate or alleviate an increasing risk associated with the role. Mitigation controls may include monitoring of the role usage or certification of the role. It may also be indicated if the current level of risk is lower than a previous value of the risk level, for example, to notify a role administrator or role owner that a risk factor associated with the role is successfully mitigated. If the current level of risk of the role is not different from the comparative level of risk, at 390, a check is performed whether the current level of risk of the role exceeds a predefined threshold. At 395, if the current level of risk of the role exceeds the predefined threshold mitigation risk strategies are formulated, for example, various mitigation controls may be implemented. If the current level of risk of the role does not exceed the predefined threshold, the process ends.

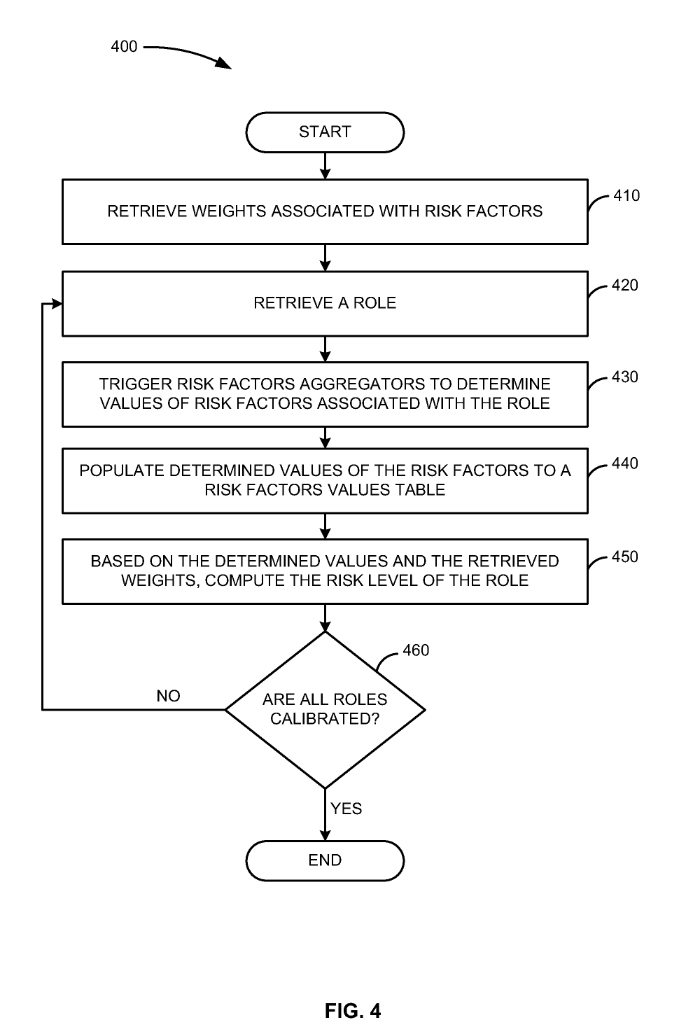

FIG. 4 illustrates process 400 for automatic calibration of risk level of roles by a risk calibration engine, according to one embodiment. At 410, weights associated with risk factors are retrieved. In one embodiment, the risk calibration engine 130 in FIG. 1 retrieves respective weights from risk factors weights table 164, kept in memory. Weights may be changed and adjusted based on organizational needs. For example, for one enterprise one risk factor may be associated with greater severity than for another enterprise. Thus, weights may be accordingly adjusted to reflect and determine the degree of influence of risk factors.

At 420, a role is retrieved. In one embodiment, the risk calibration engine 130 in FIG. 1 may retrieve the role description from an enterprise role repository, where defined roles are kept and may be accessed. For example data source 152 in FIG. 1 may include such repository that stores available roles.

At 430, risk factor aggregators are triggered to determine values of risk factors associated with the selected role. In an embodiment, the risk calibration engine 130 in FIG. 1 is configured to periodically trigger the risk factor aggregators 142-146 to regularly update the risk factors' values. In one embodiment, a job schedule may be setup in the risk calibration engine to automatically trigger risk factor aggregators. At 440, the determined values of the risk factors are populated in a risk factors values table. In one embodiment, referring again to FIG. 1, the risk calibration engine 130 periodically updates the risk factors values table 168 with current risk factors' values determined by the risk factors aggregators 142-146.

At 450, the risk level of the selected role is computed based on the determined risk factors values and the respective weights associated with the risk factors. The weights may be previously stored or evaluated, updated, and dynamically retrieved from the computer system memory. In an embodiment, the risk calibration engine 130 in FIG. 1 computes the risk level of the selected role as a weighted average of the risk factors' values, for example, using aforesaid formula 1.

At 460, a check is performed whether all available roles are calibrated. If a role has not been selected for evaluation or calibration of its risk level, then the process continuous at 420 with selecting this role. If all available roles have been selected, and respectively calibrated, the process ends. This is how the risk calibration engine 130 in FIG. 1 may compute the current level of risk of available roles in a computer system environment 100.

In an embodiment, the risk calibration engine 130 prioritizes roles based on the computed risk level. For example, available roles may be ranked in accordance to and based on the computed risk level of the roles. Therefore, roles with higher risk level or with risk level exceeding a predefined threshold may be monitored more strictly to reduce the potential fraud.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

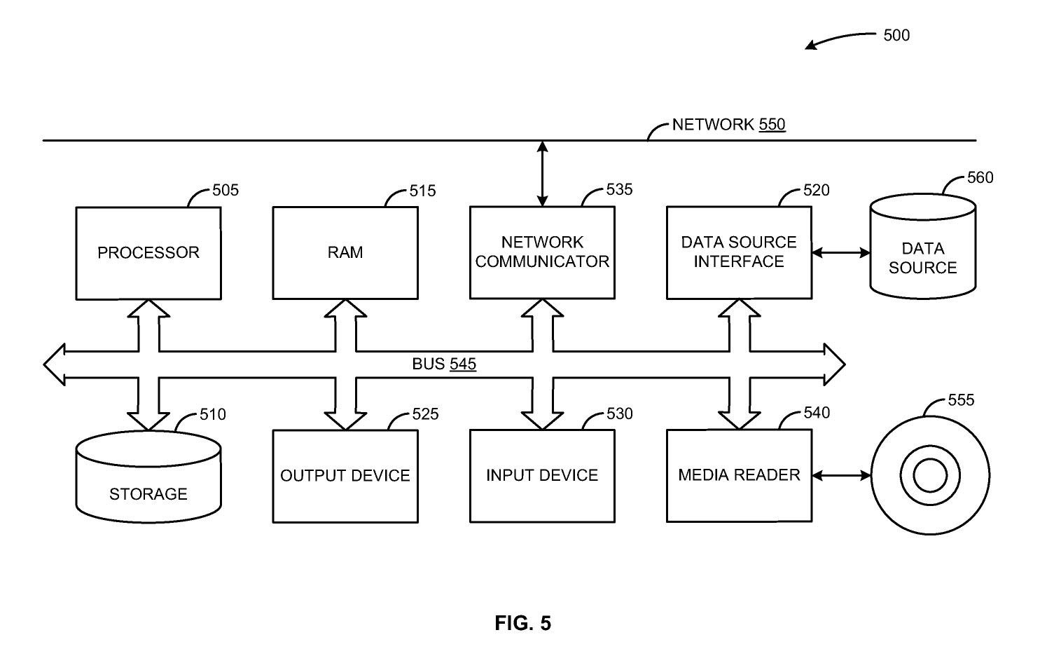

FIG. 5 is a block diagram of an exemplary computer system 500. The computer system 500 includes a processor 505 that executes software instructions or code stored on a computer readable storage medium 555 to perform the above-illustrated methods of the invention. The computer system 500 includes a media reader 540 to read the instructions from the computer readable storage medium 555 and store the instructions in storage 510 or in random access memory (RAM) 515. The storage 510 provides a large space for keeping static data where at least some instructions could be stored for later execution. The stored instructions may be further compiled to generate other representations of the instructions and dynamically stored in the RAM 515. The processor 505 reads instructions from the RAM 515 and performs actions as instructed. According to one embodiment of the invention, the computer system 500 further includes an output device 525 (e.g., a display) to provide at least some of the results of the execution as output including, but not limited to, visual information to users and an input device 530 to provide a user or another device with means for entering data and/or otherwise interact with the computer system 500. Each of these output devices 525 and input devices 530 could be joined by one or more additional peripherals to further expand the capabilities of the computer system 500. A network communicator 535 may be provided to connect the computer system 500 to a network 550 and in turn to other devices connected to the network 550 including other clients, servers, data stores, and interfaces, for instance. The modules of the computer system 500 are interconnected via a bus 545. Computer system 500 includes a data source interface 520 to access data source 560. The data source 560 can be accessed via one or more abstraction layers implemented in hardware or software. For example, the data source 560 may be accessed by network 550. In some embodiments the data source 560 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., configured for Online Analytical Processing (OLAP)), object oriented databases, and the like. Further data sources include tabular data (e.g., spreadsheets, delimited text files), data tagged with a markup language (e.g., eXtensive Markup Language (XML) data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. A computerized method to automatically calibrate a level of risk of a role in a computer system, the method comprising:
tracking by at least one aggregator at least one value of at least one risk factor associated with said role in said computer system;
retrieving from a memory at least one weight associated with said at least one risk factor;
computing by a processor a current level of risk of said role in said computer system based on said at least one value and said at least one weight of said at least one risk factor; and
calibrating said current level of risk against a comparative level of risk of said role in said computer system.

2. The method of claim 1 further comprising:
updating in said memory said at least one value of said at least one risk factor by said at least one aggregator; and
in response to said updating of said at least one value of said at least one risk factor, computing by said processor said current level of risk of said role in said computer system based on said updated at least one value and said at least one weight of said at least one risk factor.

3. The method of claim 1 further comprising:
in response to a change of said at least one weight, computing by said processor said current level of risk of said role in said computer system based on said at least one value and said changed at least one weight of said at least one risk factor.

4. The method of claim 1 further comprising:
determining whether said current level of risk of said role exceeds a threshold, and
formulating mitigation risk strategies upon determining said current level of risk of said role exceeds said threshold.

5. The method of claim 1 further comprising:
associating said at least one weight with said at least one risk factor to determine an influence degree of said at least one risk factor to said level of risk of said role.

6. The method of claim 1 further comprising:
selecting said at least one risk factor from a group consisting of:
authorization risk factor determined based on access permissions of said role to resources in the computer system;
application access risk factor determined based on access of said role to critical applications;
inherent risk factor determined based on access of said role to conflicting transactions;
incidents risk factor determined based on violations of said role;
time sensitive risk factor determined based on time a transaction of said role occurs; and
outdated certification risk factor determined based on certification of said role.

7. The method of claim 1, wherein tracking by said at least one aggregator said at least one value of said at least one risk factor associated with said user role in said computer system further comprises:
extracting from said memory at least one data value of at least one attribute of said role by said at least one aggregator.

8. A computer system to calibrate a level of risk of a role, the system including:
at least one processor and memory to execute program code related to:
at least one risk factor aggregator to track at least one value of at least one risk factor associated with said user role; and
a risk calibration engine to:
retrieve from said memory at least one weight associated with said at least one risk factor;
compute a current level of risk of said role based on said at least one value and said at least one weight of said at least one risk factor; and
indicate when said current level of risk is different compared to a stored level of risk of said role in said computer system.

9. The computer system of claim 8, wherein said at least one risk factor aggregator to update periodically in said memory said at least one value of said at least one risk factor.

10. The computer system of claim 8, wherein said risk calibration engine to:
in response to a change of said at least one weight, compute said current level of risk of said role based on said at least one value and said changed at least one weight of said at least one risk factor.

11. The computer system of claim 8, wherein said risk calibration engine to prioritize said role based on said risk level.

12. The computer system of claim 8, wherein said risk calibration engine to:
determine whether said current level of risk of said role exceeds a threshold; and
formulate mitigation risk strategies upon determining said current level of risk of said role exceeds said threshold.

13. The computer system of claim 8, wherein said at least one risk factor selected from a group consisting of:
authorization risk factor determined based on access permissions to resources of said role;
application access risk factor determined based on access of said role to critical applications;
inherent risk factor determined based on access of said role to conflicting transactions;
incidents risk factor determined based on violations of said role;
time sensitive risk factor determined based on time a transaction of said role occurs; and
outdated certification risk factor determined based on certification of said role.

14. The computer system of claim 8, wherein said at least one risk factor aggregator to extract from said memory at least one data value of at least one attribute of said role.

15. A non-transitory computer readable medium storing instructions thereon, which when executed by a processor cause a computer system to:
track by at least one aggregator at least one value of at least one risk factor associated with a role in said computer system;
retrieve from a memory at least one weight associated with said at least one risk factor;
compute a current level of risk of said role in said computer system based on said at least one value and said at least one weight of said at least one risk factor; and
calibrate said current level of risk against a comparative level of risk of said role in said computer system.

16. The computer readable medium of claim 15 storing instructions thereon, which when executed by said processor cause said computer system further to:
update in said memory said at least one value of said at least one risk factor by said at least one aggregator; and
in response to said update of said at least one value of said at least one risk factor, compute said current level of risk of said role in said computer system based on said updated at least one value and said at least one weight of said at least one risk factor.

17. The computer readable medium of claim 15 storing instructions thereon, which when executed by said processor cause said computer system further to:
determine whether said current level of risk of said role exceeds a threshold, and
formulate mitigation risk strategies upon determining said current level of risk of said role exceeds said threshold.

18. The computer readable medium of claim 15 storing instructions thereon, which when executed by said processor cause said computer system further to:
associate said at least one weight with said at least one risk factor to determine an influence degree of said at least one risk factor to said level of risk of said role.

19. The computer readable medium of claim 15 storing instructions thereon, which when executed by said processor cause said computer system further to:
select said at least one risk factor from a group consisting of:
authorization risk factor determined based on access permissions of said role to resources in the computer system;
application access risk factor determined based on access of said role to critical applications;
inherent risk factor determined based on access of said role to conflicting transactions;
incidents risk factor determined based on violations of said role;
time sensitive risk factor determined based on time a transaction of said role occurs; and
outdated certification risk factor determined based on certification of said role.

20. The computer readable medium of claim 15, wherein tracking by said at least one aggregator said at least one value of said at least one risk factor associated with said user role in said computer system further comprises:
extracting from said memory at least one data value of at least one attribute of said role by said at least one aggregator.
